(19) United States
(12) Patent Application Publication
(10) Pub. No.: US 2026/0214627 A1
(43) Pub. Date: Jul. 23, 2026

(54) RESILIENT HIGH RATE PULSE REPETITION ULTRA-WIDEBAND RANGING SYSTEM

(71) Applicant: KOREA UNIVERSITY RESEARCH AND BUSINESS FOUNDATION, Seoul (KR)

(72) Inventors: Wonsuk CHOI, Seoul (KR); Juon KIM, Gimpo-si (KR); Dong Hoon LEE, Seoul (KR)

(21) Appl. No.: 19/443,301

(22) Filed: Jan. 8, 2026

(30) Foreign Application Priority Data
Jan. 8, 2025 (KR) 10-2025-0003002
Jun. 24, 2025 (KR) 10-2025-0083168

(51) Int. Cl. H04W 64/00; H04B 1/7163; H04L 25/02; H04W 56/00

(52) U.S. Cl. CPC H04W 64/00; H04B 1/7163; H04L 25/0212; H04W 56/0015

(57) ABSTRACT

Disclosed is an ultra-wideband (UWB) ranging device and method for securing resilience. A ranging method between an initiator and a responder that perform ultra-wideband (UWB) ranging according to an example embodiment may include a first transmission operation in which the initiator transmits a poll message; a second transmission operation in which the responder receives the poll message and sequentially transmits N response messages at predetermined time intervals, where N denotes a natural number of 2 or more; and a third transmission operation in which the initiator sequentially transmits N final messages at predetermined time intervals after the N response messages are transmitted, wherein a preamble code within the synchronization (SYNC) field of each of the N response messages is selected in a predefined manner.

### CROSS-REFERENCE TO RELATED APPLICATION(S)

This application claims the benefit under 35 USC § 119(a) of Korean Patent Application No. 10-2025-0003002 filed on Jan. 8, 2025, and Korean Patent Application No. 10-2025-0083168 filed on Jun. 24, 2025, in the Korean Intellectual Property Office, the entire disclosure of which is incorporated herein by reference for all purposes.

### TECHNICAL FIELD

The present invention relates to a wireless communication security, and more particularly, to a security of ultra-wideband (UWB) communication.

### RELATED ART

User authentication based on “something you have,” such as a smart card or a smartphone, is widely used in many application fields. Wireless communication further enhances the convenience of this technology that enables a user to be authenticated without a need to take the user's device out of a pocket or a bag. Digital keys and contactless payment systems are representative application examples that authenticate a user based on something the user has through wireless communication. These application programs enhance user convenience, but erroneous verification of user proximity may allow an unauthorized user to open a car door or make a payment. Therefore, secure ranging that reliably measures the exact distance between two wireless devices is essential. Ultra-wideband (UWB) communication is one of the most promising techniques that enable secure ranging, and many recent short-range applications are adopting UWB ranging systems. This is because UWB enables precise ranging down to a centimeter unit. Due to this capability, the Car Connectivity Consortium (CCC) has adopted UWB to enhance the functionality and security of digital keys in smartphone-to-vehicle connectivity.

UWB communication utilizes the ultra-wideband to transmit short pulses in the time domain, and short pulses are advantageous since they allow more accurate time-of-arrival (ToA) measurements even in multi-path environments. With the accurate ToA, UWB communication may perform highly precise distance measurement and location estimation. However, this high bandwidth may lead to interference with other communication systems. To mitigate this, the power spectral density of UWB signals is strictly regulated. The IEEE 802.15.4z standard defines a low rate pulse repetition (LRP) mode and a high rate pulse repetition (HRP) mode based on the number of pulses transmitted for the same total transmit power. In the HRP mode, more pulses are transmitted at lower power than in the LRP mode. It is known that the LRP mode may be implemented at low cast, and the HRP mode enables high-speed communication. Smartphone manufacturers are incorporating UWB chips that support the RP mode into smartphones, and accordingly, many applications, including CCC digital keys, are using the RP mode for communication with smartphones.

In the RP mode, an UWB receiver initially detects a received UWB frame in a synchronization (SYNC) field and then estimates ToA based on a point in time at which a scrambled timestamp sequence (STS) field is received. In the HRP mode, some pulses may not be individually identified due to low power, so the receiver measures similarity through cross-correlation between a received signal and a reference signal. If a correlation peak exceeds a specific similarity threshold, the receiver detects a frame and determines a point in time at which the peak is observed as a reception point in time. This property is known to be vulnerable to an overshadowing attack. In this attack, normal pulses are distorted by stronger pulses injected by an attacker through synchronization, which leads to manipulation cross-correlation results.

In practice, previous research has shown that a UWBAD attack, which is an overshadowing attack on the SYNC field, makes a UWB frame undetectable by lowering a correlation peak, resulting in no range update in a ranging session. Also, another research showed that a ghost peak attack, which is an overshadowing attack on the STS field, may manipulate the estimated ToA. This attack generates a false correlation peak and reduces a perceived distance computed from the altered ToA. Both the ghost peak attack and the UWBAD attack may be implemented using commercially available equipment, making them serious and realistic threats.

Several studies have addressed these overshadowing attacks. Researchers have found that the ghost peak attack may be detected by verifying the consistency of cross-correlation results between sub-fields and sub-templates or between ranging sides. However, both methods simply detect attacks and do not provide countermeasures. Addressing the UWBAD attack or a ghost peak-and-UWBAD combined attack remains challenging. Existing methods focus solely on an overshadowing attack on the STS field, leaving them unable to address an overshadowing attack on the SYNC field.

A method called a random time-hopping method proposed a solution to this issue by transmitting UWB frames at random intervals. However, although UWB frames are randomly transmitted, there is a probability that an attack signal and a normal signal partially overlap. Due to this partial overshadowing, the cross-correlation results may be still manipulated, which may lead to failing in detecting a frame or incorrectly measuring a distance. As a result, time-hopping is not an ideal defense, and once an attack occurs, there is no follow-up method of addressing the attack.

The present invention proposes ultra-wideband with code randomization and channel reciprocity (UWB-CR), a novel method that enables secure ranging under overshadowing attacks. In a threat model, an overshadowing attacker is defined as an adversary that attempts to disrupt normal distance update by injecting a high-power attack signal into SNYC and/or STS fields of a UWB frame. The core idea of UWB-CR is as follows: (i) transmits a plurality of UWB frames using different random code sequences in a single ranging session, and (ii) extracts reciprocal features that enable accurate ToA measurement in manipulated frames. Although the attacker injects a code sequence identical to a normal code sequence into the SYNC field, UWB-CR may detect a received frame. Also, UWB-CR eliminates the need for a leading edge detection algorithm, which is known to be vulnerable to an overshadowing attack on the STS field, by measuring a ToA based on reciprocal features extracted when channel reciprocity is maintained. The contributions of UWB-CR are summarized as follows:
Presented is a threat model that defines common attacks of manipulating cross-correlation known as a practical threat, based on ghost peak and UWBAD models.
As far as is known, UWB-CR is the first method that may comprehensively cope with overshadowing attacks on both SYNC and STS fields, and may measure an accurate ToA even from cross-correlation results manipulated by overshadowing attacks.
It is demonstrated that UWB-CR may measure a ToA with the average error of 10.56 nanoseconds over double-sided two-way ranging (DS-TWR). This indicates that 93.02% of the ToA deviation manipulated by overshadowing attacks is corrected. In terms of distance, even when 11.3 meters is distorted, the accurate distance may be computed with an error of 0.79 meters.
In single-sided two-way ranging (SS-TWR), UWB-CR achieved a detection success rate (DSR) of 94.97%, a correct measurement rate (CMR) of 93.82%, and a ranging success rate (RSR) of 89.39%. In DS-TWR, the DSR was 90.62%, the CMR was 92.08%, and the RSR was 83.65%.

### DETAILED DESCRIPTION

### Subject

A technical subject to be achieved by the present invention is to provide an ultra-wideband (UWB) ranging device and method for securing resilience.

### Solution

A ranging method between an initiator and a responder that perform ultra-wideband (UWB) ranging according to an example embodiment includes a first transmission operation in which the initiator transmits a poll message; a second transmission operation in which the responder receives the poll message and sequentially transmits N response messages at predetermined time intervals, where N denotes a natural number of 2 or more; and a third transmission operation in which the initiator sequentially transmits N final messages at predetermined time intervals after the N response messages are transmitted, wherein a preamble code within the synchronization (SYNC) field of each of the N response messages is selected in a predefined manner.

### Effect

According to example embodiments of the present invention, it is possible to detect an overshadowing attack on a preamble field.

Also, according to the present invention, although the overshadowing attack on the preamble field is made, it is possible to measure and update the accurate distance.

The present invention is compatible with the IEEE 802.15.4-2020z standard and may operate in Qorvo DW3000 that is a commercial UWB chip.

### BRIEF DESCRIPTION OF DRAWINGS

To more fully understand drawings cited in the detailed description of the present invention, the detailed description of each drawing is provided.

FIG. 1 is to describe a round-trip time (RTT) measured in two-way ranging (TWR).

FIG. 2 illustrates an example of a leading edge detection (LED) algorithm.

FIG. 3 illustrates a process in which an attacker injects an overshadowing signal into synchronization (SYNC) and/or scrambled timestamp sequence (STS) fields.

FIG. 4 illustrates overview of the present invention.

FIG. 5 illustrates comparison between an N-time ranging session and a multipacket structure.

FIG. 6 is to describe five cases occurring in the process of handling a proposed technique (ultra-wideband with code randomization and channel reciprocity (UWB-CR)).

FIG. 7 is a graph showing the tradeoff between a total time for ranging in double-sided two-way ranging (DS-TWR) and a detection failure rate as a function of N.

FIG. 8 is a graph showing the average peak error of maximum peak Pₛₜₛ and SYNC peak P_{sync} as a function of K.

FIG. 9 shows a denial-of-ranging rate and a distance reduction rate due to manipulated ToA measurement.

FIG. 10 is a graph showing an empirical cumulative distribution function (ECDF) of a distance error as a function of Kₛₜₛ.

FIG. 11 is a graph showing a correct measurement rate (CMR) and a ranging success rate (RSR) in outdoor channel environments as a function of K.

FIG. 12 is a flowchart illustrating an ultra-wideband ranging method according to an example embodiment of the present invention.

### DETAILED DESCRIPTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

Hereinafter, as the background art of the present invention, high rate pulse repetition (HRP) ultra-wideband (UWB)'s physical layer configuration, ranging method, and frame reception process are initially described and then channel reciprocity is introduced.

### 1. HRP UWB Physical Layer

The current UWB communication standard, IEEE 802.15.4z, specifies a low rate pulse repetition (LRP) mode and an HRP mode as the physical layer configuration. UWB communication uses an ultra-wide frequency bandwidth, but its transmit power is strictly limited since interference with other communication systems may occur. In the LRP mode, fewer pulses are transmitted at higher power. In the HRP mode, more pulses are transmitted at lower power. However, both modes maintain the same total transmit power. The LRP mode is known to be implementable at low cost, and the RP mode supports high-speed communication. This property shows unique advantages of each mode. Application programs primarily use RP UWB communication (e.g., Car Connectivity Consortium (CCC) digital key) since it connects to a smartphone. The smartphone is equipped with an HRP UWB chip to take the advantage of high-speed communication.

An HRP UWB frame is constructed in the following sequence: synchronization (SYNC), start of frame delimiter (SFD), scrambled timestamp sequence (STS), physical layer header (PHR), and data payload field. The SYNC field contains a preamble, a code sequence that is repeated a predetermined number of times, for frame detection and synchronization between an initiator and a responder. In IEEE 802.15.4, a total of 24 different code sequences are defined. Among them, eight code sequences have the 32-bit length and 16 code sequences have the 127-bit length. These code sequences are designed to have low inter-correlation. Also, as the name suggests, dynamic preamble selection (DPS) may dynamically change a preamble. Once the DPS is activated, only eight code sequences with the 127-bit length may be used as the preamble.

### 2. HRP UWB Ranging

2.1 Two-way Ranging. The IEEE 802.15.4z standard specifies three methods, single-sided two-way ranging (SS-TWR), double-sided two-way ranging (DS-TWR), and time difference of arrival (TDoA) for HRP UWB ranging.

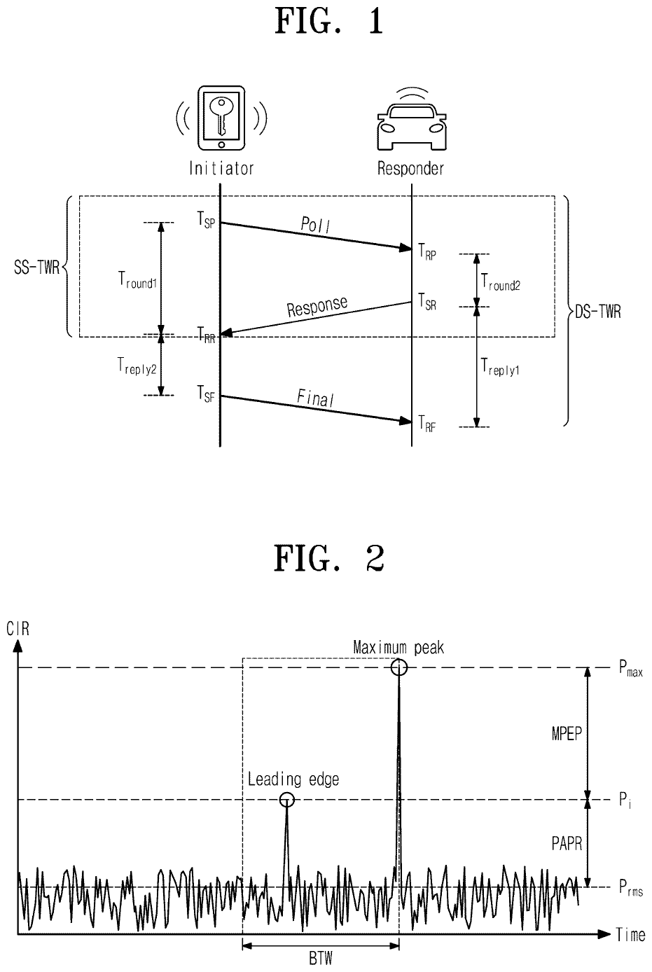

Two TWR methods, SS-TWR and DS-TWR, are described. In the methods, both an initiator and a responder do not require time synchronization. On the other hand, in the TDoA method, a plurality of anchor nodes need to be synchronized with each other. In TWR, the initiator and the responder exchange frames to measure a round-trip time (RTT) and based on this, estimate a time of flight (ToF). FIG. 1 illustrates an RTT measurement process in SS-TWR and DS-TWR. Here, a poll transmission time, a poll reception time, a response transmission time, a response reception time, a final transmission time, and a final reception time are indicated as T_{SP}, T_{RP}, T_{SR}, T_{RR}, T_{SF}, and T_{RF}, respectively. In the case of the transmission time, a transmitter simply measures a time right before transmitting a frame (poll, response, or final). In the case of the reception time, a receiver needs to measure the ToA of a corresponding frame immediately after receiving the frame. These timestamps are essential to compute the ToF, and through this, a distance between the initiator and the responder may be estimated. In SS-TWR, a distance d_{SS} is computed as follows.

$${d}_{SS} = c \cdot \frac{{T}_{round 1} - {T}_{reply 1}}{2} \qquad [ Equation 1 ]$$

Here, c represents the speed of light. The responder computes T_{reply1} as T_{SR}−T_{RP}. This value is included in a response frame and transmitted to the initiator. However, it is known that the distance measured in SS-TWR is sensitive to have errors due to the clock offset between the initiator and the responder.

In DS-TWR, the initiator transmits a final frame that includes T_{reply2}=T_{SF}−T_{RP}. The responder receives the final frame and then computes a distance d_{DS} as follows.

$${d}_{DS} = c \cdot \frac{{T}_{round 1} \cdot {T}_{round 2} - {T}_{reply 1} \cdot {T}_{reply 2}}{{T}_{round 1} + {T}_{reply 1} + {T}_{round 2} + {T}_{reply 2}} \qquad [ Equation 2 ]$$

DS-TWR may correct clock offset errors, so is regarded as a more reliable method.

2.2 Cross-correlation. Ranging accuracy depends on the precise measurement of ToA values indicated as T_{RP}, T_{RR}, and T_{RF}. In the HRP mode, the ToA is estimated based on the reception time of the STS field. However, since the receiver may not individually identify pulses in the HRP mode, the STS field is detected through cross-correlation and, in this process, a channel impulse response (CIR) is output. Since the CIR reflects a propagation path and a time delay of a signal, the ToA may be accurately estimated. When a reference signal x[·] and a received signal y[·] are given, the CIR is determined as follows.

$${CIR}_{x , y} ( τ ) = {\sum }_{n = 0}^{\vert x \vert - 1} x [ n ] \cdot y [ n + τ ] \qquad [ Equation 3 ]$$

In the STS field, the reference signal represents a cryptographic pseudo-random number generated using a session key shared by the initiator and the responder. This signal is stored in a local template. The cross-correlation is computed between the received STS field and its local template. In the CIR, a location of a peak represents a time delay (lag) in which the reference signal x[·] and the received signal y[·] are most correlated. Appearing of a plurality of peaks in the cross-correlation represents the presence of multi-path propagation. Ideally, a leading edge corresponds to reception of a line-of-sight (LOS) signal. In general, the LOS signal is used for ranging.

2.3 leading edge detection (LED). In an ideal channel (i.e., channel without noise, multi-path interference, or distortion), the CIR may contain a single distinct peak corresponding to the LoS signal. This peak indicates the exact arrival time of a transmission signal, which enables accurate synchronization and ToA estimation. However, in real-world environments, the CIR contains a plurality of peaks due to multi-path propagation. This is because signals are reflected from obstacles and arrive at the receiver at different times. In such a case, the receiver needs to identify the leading edge of a most initially arrived signal (generally, LoS component) to secure accurate synchronization and ranging accuracy. In a multi-path channel, a maximum peak occurs at a point at which a non-line-of-sight (NLoS) signal is received. Therefore, the leading edge in which the LoS signal is received needs to be detected, which is generally present around the maximum peak. In general, a back-search algorithm searches for a peak around the maximum peak under a specific condition. The back-search algorithm (or leading edge detection algorithm) considers peaks within a back-search time window (BTW) as leading edge candidates, and determines a peak that satisfies the following two conditions as a leading edge among the candidates.

$$\frac{{P}_{max}}{{P}_{i}} < MPEP ∧ \frac{{P}_{i}}{{P}_{rms}} > PAPR \qquad [ Equation 4 ]$$

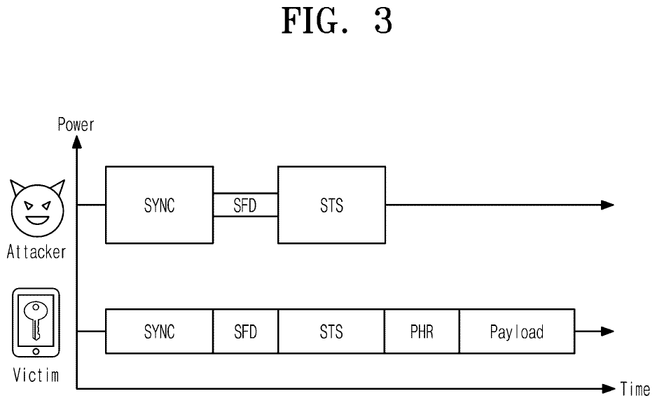

Here, MPEP represents a maximum peak-to-earlier peak ratio, and PAPR represents a peak-to-average power ratio. The maximum peak power and the average power are indicated as Pₘₐₓ and Pᵣₘₛ, respectively. FIG. 2 illustrates a leading edge detection (LED) algorithm.

### 3. HRP UWB Frame Reception

Before starting UWB ranging, the initiator and the responder need to initially exchange a preamble code index and a session key. Different preamble codes serve to distinguish between a plurality of pairs of signals within a shared environment. That is, an initiator-responder pair need to use the same preamble code identified by the agreed-upon preamble code index. This index is typically exchanged in an initial setting stage, or stored in previous communication. The session key is pre-shared between a transmitter and a receiver to generate and verify the STS field. The STS field enhances security using a cryptographic pseudo-random sequence.

The receiver initially detects an incoming UWB frame through energy detection and cross-correlation with a known preamble sequence. Since the SYNC field contains a predefined preamble code, the receiver may use cross-correlation to estimate start of a frame. Then, the receiver determines whether there is a time delay in which the peak amplitude exceeds a specific threshold δₚ. If the peak amplitude is higher than the threshold, the receiver accepts the corresponding UWB frame. Then, the receiver computes cross-correlation between a received STS sequence (yₛ) and a local template (xₛ), and determines the CIR. Then, the LED algorithm finds the leading edge in the CIR. The amplitude of the detected leading edge needs to exceed the specific threshold δₛ. Therefore, two important requirements are presented for the receiver to successfully estimate the ToA. CIRs (CIRₓ_{ₚ}_{,y}_{ₚ} and CIRₓ_{ₛ}_{,y}_{ₛ}) require time delays (τₚ and τₛ), respectively, during which peaks with amplitude exceeding a threshold need to be observed.

$${CIR}_{{x}_{p} , {y}_{p}} ( {τ}_{p} ) \geq {δ}_{p} ∧ {CIR}_{{x}_{s} , {y}_{s}} ( {τ}_{s} ) \geq {δ}_{s} \qquad [ Equation 5 ]$$

Since the ToA is measured only for a successfully detected frame, the UWB frame needs to meet both conditions for the receiver to measure the ToA.

### 4. Channel Reciprocity

In wireless communication, channel reciprocity is the principle that channel characteristics (e.g., delay, signal strength, and phase shift) between the transmitter and the receiver are approximately identical. That is, the CIRs computed at the initiator and the responder are similarly distributed. A time duration in which channel characteristics are maintained is called a coherence time. If a ranging session exceeds the coherence time, channel characteristics between the initiator and the responder may vary, which may lead to distance computation errors. According to the previous research, since the pulse duration in a UWB communication system is short, devices may easily achieve the channel reciprocity during a ranging session.

Hereinafter, presented is a threat model in which an attacker interferes with UWB communication ranging. If either of an initiator-responder pair fails to detect a UWB frame or to accurately estimate the ToA of the corresponding frame, the distance may be incorrectly measured. If detection of the incoming UWB frame fails, the initiator-responder pair do not update the distance and, as a result, mistake the previously measured distance as the current distance. In this threat model, the primary objective of the attacker is to cause this failure. That is, the attacker may overshadow a normal UWB frame. The UWB frame overshadowed in the SYNC field or the STS field manipulates a CIR measured in each corresponding field. For the given UWB frame, the CIR is measured twice through cross-correlation for both the SYNC field and the STS field. The first CIR is used to detect the incoming UWB frame, and the second CIR is used to estimate the ToA. Therefore, the attacker may make an overshadowing attack on one field or both fields. Hereinafter, how distance measurement is disrupted when the CIR is targeted for attack in different scenarios. Here, it is assumed that the attacker is using a widely available commercial off-the-shelf (COTS) UWB chip.

On SYNC field. To manipulate the CIR measured from the SYNC field, the attacker my inject a code sequence that differs from one used between the initiator and the responder. This is simultaneously performed with wireless transmission of the normal SYNC field. Due to this different code sequence injection, the UWB frame is overshadowed in the SYNC field. The attacker makes the similarity of code sequence be mis-interpreted to be low regardless of whether the receiver is the initiator or the responder. According to the UWB standard, if the similarity between the code sequence of the received UWB frame and a predefined code sequence is less than (or less than or equal to) a specific threshold, the receiver may discard the corresponding UWB frame. Since the similarity is measured based on the CIR, the low similarity indicates that the amplitude of all peaks within the CIR is less than (or less than or equal to) the specific threshold δₚ. Then, the initiator-responder pair may not update the distance since the UWB frame is discarded. Finally, it is assumed that the attacker generates only a code sequence set defined in the standard, which indicates that the COTS UWB chip may not use a randomly generated sequence.

On STS field. For the STS field, the attacker injects a sequence randomly generated with high power at the exact same point in time at which the normal STS field is wirelessly transmitted. Due to this randomly generated sequence, the UWB frame is overshadowed in the STS field, and the receiver estimates the incorrect ToA. Since the sequence of the STS field is a pseudo-random number generated based on a pre-shared secret key, the attacker may not predict which sequence is to be used. Therefore, the attacker injects a randomly generated sequence. If a peak is generated at an earlier point in time in the manipulated CIR and the amplitude of the peak exceeds the threshold δₛ, the LED algorithm may detect this fake peak as the leading edge, which results in estimating the incorrect ToA. If the ToA is inaccurate, the ToF becomes inaccurate, which directly affects distance measurement. Also, if a measured value exceeds an allowable limit, the initiator-responder pair may not update the distance. For example, the maximum measurable range in the UWB communication is typically known as 100 meters. If the distance exceeding the allowable limit is measured, the initiator-responder pair may not update the distance.

High-output signal injection is highly likely to manipulate the CIR. Therefore, in this threat model, the attacker is categorized by strength of an injected pulse, which is denoted as K=(K_{sync}, Kₛₜₛ). That is, the attacker injects a pulse with K_{sync} and Kₛₜₛ times stronger than a normal pulse on the SYNC field and the STS field, respectively. Also, it is assumed that the attacker may adjust this signal strength when performing an overshadowing attack. For example, K=(0, kₛₜₛ) attack represents an overshadowing attack that targets only the STS field, and the SYNC field remains unaffected. Finally, it is assumed that the attacker may overshadow response and final messages that are UWB frames. Since a poll message is a first transmitted UWB frame in a two-way ranging (TWR) session, the attacker has difficulty in estimating a transmission point in time of the poll message. Typically, intervals (T_{reply1} and T_{reply2}) are set in a UWB device, and may be observed as static values. On the other hand, the poll message is known to be aperiodically transmitted due to energy saving and collision avoidance.

Hereinafter, the proposed technique UWB-CR that is designed to ensure current distance measurement even under overshadowing attacks defined in the threat model is described. Initially, three key questions are presented to provide better understanding of UWB-CR. Answers to these questions are design requirements of UWB-CR.
Question 1. How does UWB-CR acquire the correct CIR although the attacker overshadows the SYNC field?
Question 2. How long does it take for UWB-CR to acquire the correct CIR although the attacker overshadows the SYNC field?
Question 3. How does UWB-CR measure a correct ToA although the attacker overshadows the STS field?

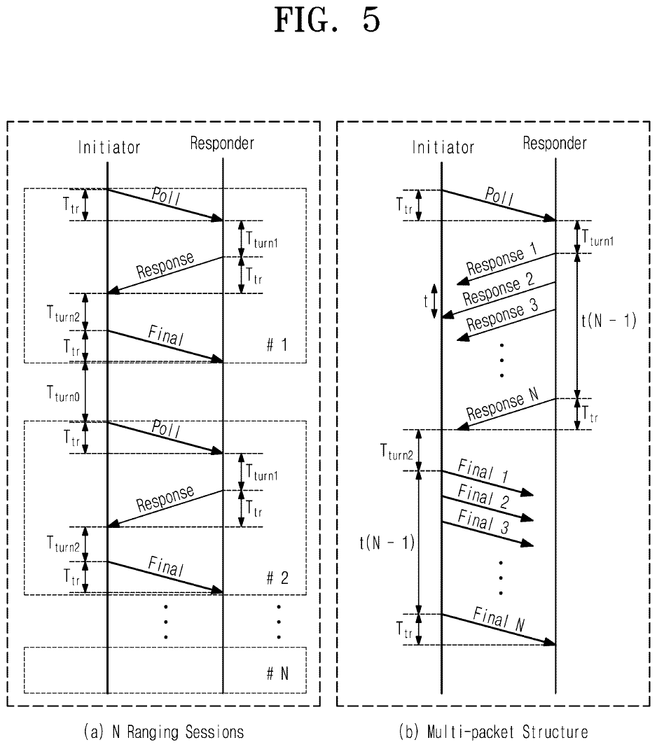

To answer these questions, UWB-CR is divided into three portions: i) code randomization), ii) multi-packet structure), and iii) channel reciprocity-based ToA estimation. FIG. 4 illustrates the overview of UWB-CR and these three key components.

### 1. Code Randomization

The attacker may overshadow the SYNC field by injecting a high-power code sequence that differs from a code sequence used by a legitimate initiator-responder pair. The injected sequence interferes with a legitimate code sequence, disrupting accurate CIR measurement. In a current UWB system, the same code sequence is repeatedly used for each ranging session. Therefore, it is easy for the attacker to inject a different sequence and to cause interference. However, in UWB-CR, the initiator-responder pair randomly shares a preamble code index each time the initiator-responder pair transmits a UWB frame. This makes it difficult for the attacker to accurately predict all code sequence indices. There is a probability that at least once a UWB frame transmitted by the attacker matches a frame transmitted by the legitimate initiator-responder pair. As mentioned earlier, a total of eight code sequence indices (i.e., 13, 14, 15, 16, 21, 22, 23, and 24) are available for DPS in the 4Z standard. UWB-CR selects one of these eight code sequence indices. In the present invention, since it is assumed that the attackers use a COTS UWB chip, they may only use eight indices. Therefore, the probability that the attacker transmits the same code sequence is 1/8.

Since the initiator-responder pair already shares a secret key for generating a pseudo-random number to be used in the STS field, there is no need to share an additional secret key to generate a random code sequence index. The code sequence index may be determined from first three bits of a hash value generated using a pseudo-random number as input. These eight values sequentially correspond to eight code indices (i.e., 13, 14, 15, 16, 21, 22, 23, and 24). According to an example embodiment, a value of the first three bits of the hash value and a code index may be matched in advance. That is, a transceiver (or initiator and responder) may truncate each 3 bits from the beginning of the 4096-bit STS field for the poll message, and may use the same as a ternary code index. Therefore, no additional information exchange is not required to agree on a random code.

### 2. Multi-Packet Structure

Although UWB-CR uses a random code sequence index, the probability that the attacker may manipulate a CIR by overshadowing the SYNC field is still 7/8. Therefore, UWB-CR needs to repeatedly transmit different code sequences until a code sequence transmitted by the attacker matches a sequence transmitted from the legitimate pair. As the number of transmissions N increases, the probability that the attacker fails to manipulate the CIR also increases to (7/8)^{N}. As illustrated in (a) of FIG. 5, the total time Tᵣₛ required for N ranging sessions is computed as follows:

$${T}_{rs} = N \cdot ( 3 {T}_{tr} + {T}_{turn 1} + {T}_{turn 2} ) + ( N - 1 ) \cdot {T}_{turn 0} \qquad [ Equation 6 ]$$

Here, Tₜᵣ, Tₜᵤᵣₙ₁, Tₜᵤᵣₙ₂, and Tₜᵤᵣₙ₀ denote a frame transmission time, a poll-to-response turnaround time (T_{reply1} of FIG. 1), a response-to-final turnaround time (T_{reply2} of FIG. 1), and a final-to-poll turnaround time, respectively, and Tₜᵤᵣₙ₀ denotes a variable. To minimize an amount of time used to maintain the distance without being updated, an amount of time required to transmit the same code sequence needs to be minimized. This reduces the probability that the attacker remains undetected for a long period of time.

To shorten this time, the present invention designs a multi-packet structure that transmits N response messages and N final messages in a single ranging session. When repeating the basic ranging session N times, a total of 3×N messages are transmitted, whereas, in the multi-packet structure, (2×N+1) messages are transmitted in a single ranging session. Additionally, to eliminate round-trip-time (RTT) delay, a protocol that transmits N final messages after consecutively transmitting N response messages at guard time interval t is designed. As illustrated in (b) of FIG. 5, the total time Tₘₚ required for a single ranging session in the multi-packet structure is computed as follows.

$${T}_{mp} = 3 \cdot {T}_{tr} + {T}_{turn 1} + {T}_{turn 2} + 2 \cdot t \cdot ( N - 1 ) \qquad [ Equation 7 ]$$

Since the turnaround time is a time required for state transition between the initiator and the responder, the guard time to prevent signal interference is significantly shorter than the turnaround time. As a result, the multi-packet structure may efficiently measure the correct distance in a short period of time.

Since it is uncertain which frame among the N transmitted frames will be detected, T_{reply1} and T_{reply2} differ depending on the detected frame in the multi-packet structure (see FIG. 4). Therefore, the initiator and the responder may include an index of the detected frame in a data payload of a message subsequently transmitted. That is, after receiving a response frame, the initiator identifies index i and includes the same in a data payload of a final frame. Let the detected response frame be an i^{th} frame among the N transmitted frames and the detected final frame be a j^{th} frame among the N frames. The responder computes T_{reply1} and T_{reply2} as follows.

$${T}_{reply 1} = t \cdot ( i - 1 ) + {T}_{turn 1} \qquad [ Equation 8 ]$$

$${T}_{reply 2} = t \cdot ( N - 1 + j - 1 ) + {T}_{turn 2} \qquad [ Equation 9 ]$$

### 3. Channel Reciprocity-Based ToA Estimation

The LED algorithm is known to be vulnerable to overshadowing attacks. For example, the attacker may overshadow the STS field, causing the LED algorithm to measure the incorrect ToA from the manipulated CIR. To ensure the accurate ToA, UWB-CR is designed to compute the ToA without the LED algorithm. Instead of using the LED algorithm, UWB-CR extracts reciprocal features and computes the ToA based on the extracted reciprocal features. A UWB channel is known to exhibit reciprocity, enabling this approach.

The poll message is assumed not to be a target of overshadowing. Therefore, UWB-CR extracts channel characteristics from the corresponding message and uses the same as reciprocal features. The present invention defines the following three reciprocal features from the poll message.
α: Time interval between the maximum peak and the leading edge of the STS field of the poll message (P_{sts,poll}−P_{toa,poll})
β: Time interval between the SYNC peak (maximum peak of SYNC field) and the leading edge of the poll message (P_{toa,poll}−P_{sync,poll})
γₚ: Time interval between the SYNC peak and the maximum peak of the STS field of the poll message (P_{sts,poll}−P_{sync,poll})

Here, the leading edge and the maximum peak are peaks observed in the CIR measured in the STS field, and the SYNC peak corresponds to a peak observed in the CIR measured in the SYNC field. Since the SYNC field includes a repeating preamble code sequence, a plurality of peaks are observed in the CIR. A first peak within the CIR is defined as the SYNC peak.

The primary approach that computes the correct ToA from the manipulated CIR is based on observation that the SYNC peak and the maximum peak are more reliable than the leading edge when measuring the ToA from the manipulated CIR. The reasons are as follows: (1) If the SYNC field is heavily overshadowed, the SYNC peak is significantly weakened and accordingly, the corresponding UWB frame is not detected. This indicates that the SYNC field is not heavily overshadowed in any UWB frame for which ToA is measurable. As a result, the SYNC peak is hardly affected or only slightly affected and serves as a reliable reference point. (2) The attacker generates a fake leading edge by overshadowing the STS field, but does not generate the fake maximum peak. Therefore, the maximum peak is also relatively less affected and serves as a reliable reference point. In most cases, it is observed that the UWB-CR may compute the more accurate ToA when the maximum peak is used as the reference point. However, if the attacker overshadows the STS field with high power, the reliability of the maximum peak may also be lowered. In this case, it is preferable to use the SYNC peak as the reference point. For this reason, UWB-CR may select a more reliable reference point between the SYNC peak and the maximum peak depending on the degree of manipulation.

To evaluate the reliability of the maximum peak, the time interval between the SYNC peak and the maximum peak is measured. Since the SYNC peak maintains consistency within the small error range, the change in the time interval may be attributed to the maximum peak. As long as the STS field is not significantly affected by high-power overshadowing, the maximum peak may be more reliable than the SYNC peak. Le the time interval between the SYNC peak and the maximum peak in a response message and a final message be γᵣ and γ_{f}, respectively. The initiator and the responder compute |γₚ−γ_{f}| and |γₚ−γᵣ|, respectively. With the assumption that if these values are greater than a back-search time window (BTW), the SYNC peak is more reliable as the reference point, ToA is computed based on β. Otherwise, the maximum peak is more reliable and the ToA is computed based on α. Algorithm 1 represents a ToA computation method of UWB-CR. That is, when the interval between the maximum peak of the SYNC field and the maximum peak of the STS field for the response message and/or the final message is γ′, if γ−γ′ is greater than the BTW, ToA of the response message or the final message is a value acquired by adding p to the maximum peak of the SYNC field, and otherwise, a value acquired by subtracting a from the maximum peak of the STS field.

[Algorithm 1]
Algorithm 1: Channel Reciprocity-based ToA Estimation

| Data: α, β, γₚ, yₚ, yₛ, δₚ, δₛ, BTW | | | |
|---|---|---|---|
| Result: ToA Pₜₒₐ | | | |
| /*Generate template xₛ, Extract code sequences xₚ*/ | | | |
| P_{sync} ← CrossCorr(xₚ, yₚ) if P_{sync} ≥ δₚ then | | | |
| \| | Pₛₜₛ ← CrossCorr(xₛ, yₛ); | | |
| \| | if Pₛₜₛ ≥ δₛ then | | |
| \| | \| | γ = Pₛₜₛ − P_{sync}; | |
| \| | \| | if \|γₚ − γ\| > BTW then | |
| \| | \| | \| | Pₜₒₐ ← P_{sync} + β |
| \| | \| | else | |
| \| | \| | \| | Pₜₒₐ ← Pₛₜₛ − α |

| | | |
|---|---|---|
| \| | \| | end |

| \| | end |
|---|---|
| else | |
| \| | Frame Drop; |

end

Hereinafter, how UWB-CR performs against overshadowing attacks is evaluated. Initially, a receiver design and a channel environment for simulation are described. Then, three performance metrics are defined, and the number of frames in the multi-packet structure is determined. Then, the experimental results based on performance and distance errors under various channel conditions are presented.

### 1. Experiment Setup

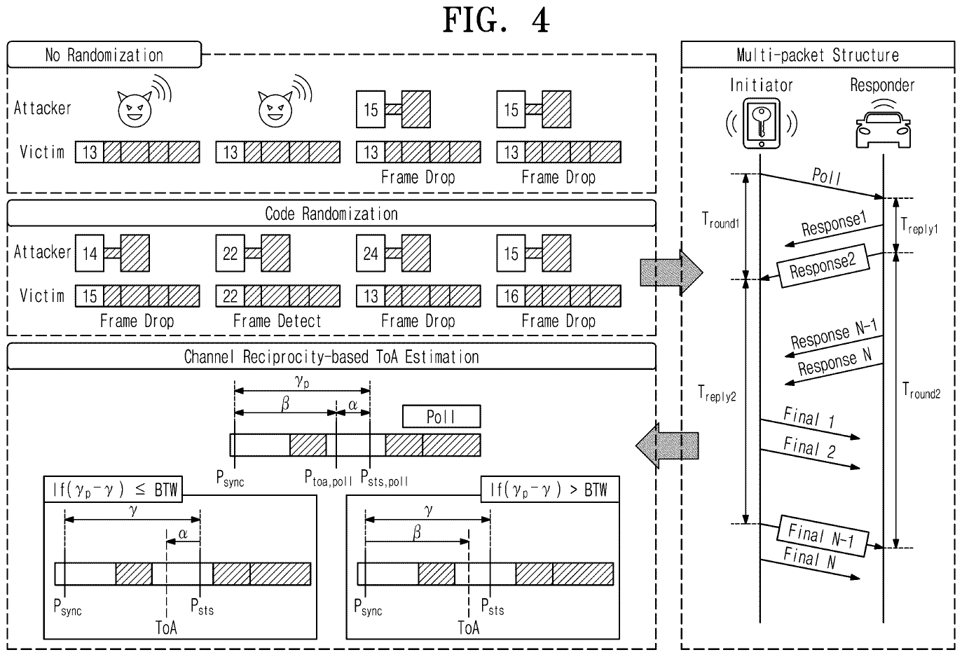

1.1 Receiver design. UWB pulses within the SYNC and STS fields are generated using 8-order Butterworth pulses with a 3 dB bandwidth of 500 MHz. The standard details four possible packet structures according to placement of the STS field within the packet. For UWB-CR implementation, as illustrated in FIG. 3, the STS field adopts Configuration 1 present between the SFD and the PHR. The SYNC field includes 16 repetitions of symbols with a 127-length ternary code sequence. The STS field includes 4,096 BPSK-modulated pulses of which average PRF is 62.4 MHz, which is the default parameter of the IEEE 802.15.4z standard. The payload length is assumed as 127 bytes corresponding to the maximum capacity supported by the UWB frame according to the standard.

While the ToA of the response message and the ToA of the final message are not estimated using the LED algorithm, the ToA of the poll message may still be estimated using the LED algorithm. Therefore, specific values of the MPEP and the PAPR, which are parameters of the LED algorithm, are required. For evaluation of the present method, values that minimize ranging errors are simply selected in an attack-free state. Due to multi-path components, some ranging errors are unavoidable. Also, in PKES that is a general application used for UWB ranging, it is known that the ToA estimation error of up to 7 ns is allowable. To determine MPEP and PAPR values, the number of cases in which the ToA estimation error exceeds 7 ns was computed. General MPEP and PAPR value pairs used in previous research were utilized. Among them, an error exceeding 7 ns less appeared in (10,8), (15,8), (20,8), and (25,8). Among them, (10,8) exhibited slightly better performance, but the overall performance difference was not great. Therefore, (10,8) were used as MPEP and PAPR values.

1.2 Channel environment. The IEEE 802.15.4a task group defined a plurality of UWB channel models to evaluate the performance in various environments in consideration of multi-path characteristics. These environments are categorized based on the arrival time and the decay time of multi-path components, scale fading, and frequency dependence. The present invention evaluates the present method under a total of eight channel environments, including LoS and NLoS conditions, each in an environment having a unique impulse response, such as residential, office, outdoor, and industrial settings. For evaluation, the UWB communication frequency was set to 6.5 GHz, and the sampling rate of the receiver was set to 1 GHz.

1.3 Performance metrics. To present performance metrics used to evaluate the present method, cases observed while the receiver that implements the present method processes a UWB frame are defined. These five cases are as follows.
Detection Failure (DF): A case in which a UWB frame becomes undetectable due to a manipulated CIR measured on the SYNC field
Manipulated ToA (MToA): A case in which a UWB frame is overshadowed, so ToA measured on the STS field is manipulated, and a case in which a ToA reduction amount is greater than 7 ns
Nominal ToA (NToA): A case in which a UWB frame is overshadowed, so ToA measured on the STS field is manipulated, and a case in which a ToA reduction amount is less than 7 ns
Correct ToA Measurement (CToA): A case in which UWB-CR successfully measured ToA with an error of less than or equal to a predefined threshold δ
Incorrect ToA Measurement (IToA): A case in which UWB-CR failed to measure the correct ToA with an error exceeding a predefined threshold δ
Denial-of-ranging Case: A case in which a UWB frame is overshadowed, so distance reduction exceeds 100 m.

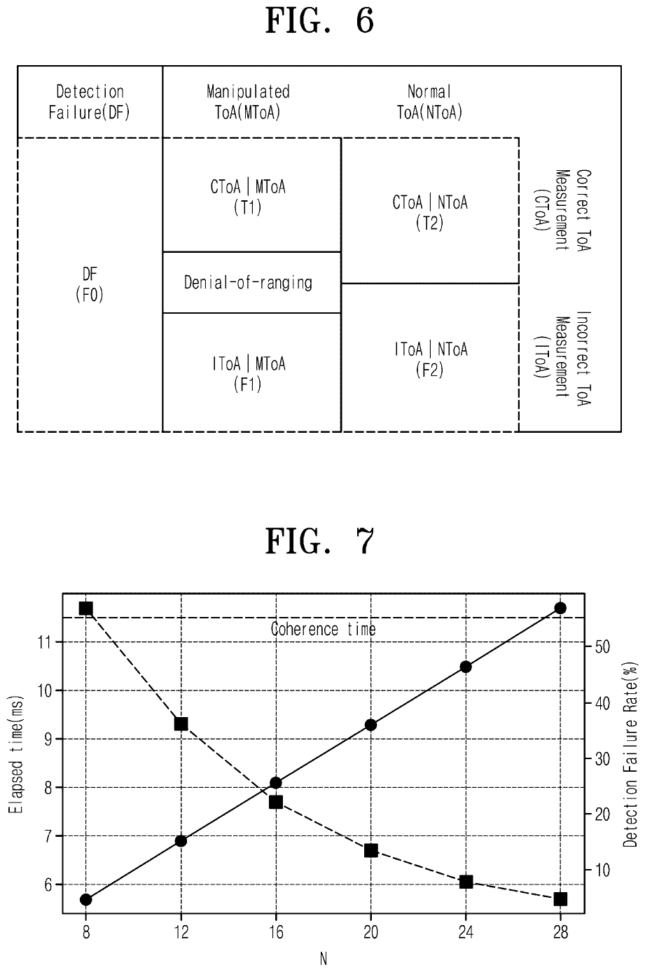

To easily identify the results of UWB-CR, case A under the condition of case B is represented as A|B. For example, a case in which UWB-CR successfully recovered the ToA from the manipulated ToA is represented as CToA|MToA. Based on cases illustrated in FIG. 6, three performance indices are presented.
Detection Success Rate (DST): A rate at which UWB frames are successfully detected. The DSR is computed as follows.

$$DSR = \frac{T 1 + T 2 + F 1 + F 2}{F 0 + T 1 + T 2 + F 1 + F 2} \qquad [ Equation 10 ]$$

Corrected Measurement Rate (CMR): A rate at which ToA is successfully measured regardless of its modification. The CMR is computed as follows.

$$CMR = \frac{T 1}{T 1 + F 1} \qquad [ Equation 11 ]$$

Ranging Success Rate (RSR): A rate at which ranging sessions are successfully completed regardless of whether the ToA is manipulated. The RSR is computed as follows.

$$RSR = \frac{T 1 + T 2}{F 0 + T 1 + T 2 + F 1 + F 2} \qquad [ Equation 12 ]$$

As described above, denial-of-ranging occurs when the distance exceeds the measurable range of UWB communication. In general, this case corresponds to a case in which the distance my not be measured, so is excluded from the performance evaluation. Instead, a distance error reduction rate when applying UWB-CR is measured to evaluate how well UWB-CR handles this case. This is called a distance error reduction rate.

### 2. The Number of Frames in Multi-Packet Structure

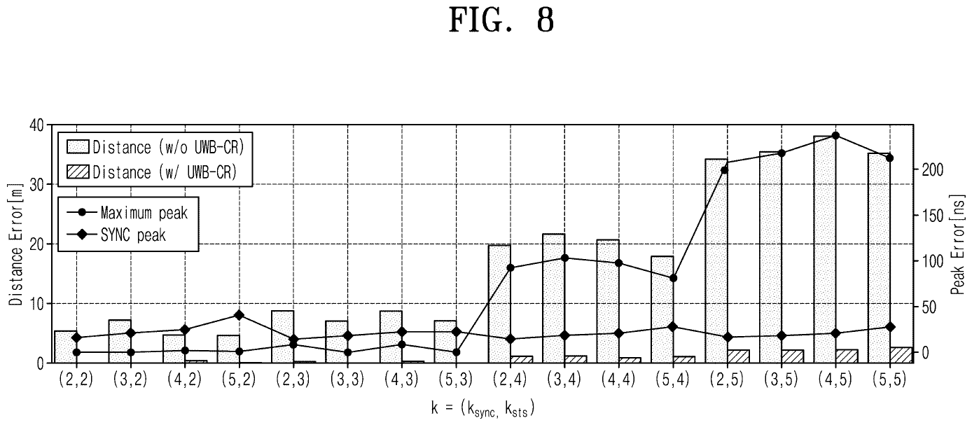

As described above, in UWB-CR, the number of frames N transmitted in a single ranging session needs to be determined. As illustrated in FIG. 7, N denotes a tradeoff parameter between a total amount of time used for ranging and a detection failure rate. As N increases, a rate at which UWB frames are not detected decreases. On the other hand, since the number of UWB frames to be transmitted increases, an amount of time used for ranging also increases. At the same, UWB-CR needs to complete a single ranging session within a coherence time to maintain channel reciprocity. In the UWB communication field, the coherence time T_{c} is defined as follows.

$${T}_{c} = \frac{1}{2 \cdot S \cdot {f}_{D}} \qquad [ Equation 13 ]$$

Here, S denotes the sample density, and f_{D} denotes the maximum Doppler shift. The sample density indicates the number of samples per symbol, and is computed as a ratio of a sampling rate (fₛ) to the bandwidth (f_{BW}). In the present evaluation, fₛ and f_{BW} are set as 1 GHz and 499.2 MHz, respectively, which are typically used values. The maximum Doppler shifter is the largest frequency variation, and is a value acquired by dividing the multiplication of the relative velocity (v) and the carrier frequency (f_{c}=6.5 GHz) by the speed of light (c). Considering a CCC digital key application scenario, it is assumed that the maximum speed v of the UWB device is 3.6 km/h, the average adult walking speed. As a result, the coherence time is computed as 11,500 μs.

In UWB-CR, (2·N+1) frames are transmitted in a single ranging session. Therefore, an amount of time used for ranging with (2·N+1) frames is computed as Tₘₚ=3·Tₜᵣ+Tₜᵤᵣₙ₁+Tₜᵤᵣₙ₂+2·t·(N−1) In the present experimental setup, the frame transmission time (Tₜᵣ) is about 798 s at a default data rate of 6.81 Mbps. In the case of the turnaround time, Tₜᵤᵣₙ₁ and Tₜᵤᵣₙ₂ are set to 900 μs and 300 μs, respectively, which are values typically used in the Qorvo DW3000 UWB chip. Applying these values, Tₘₚ is expressed as 2t(N−1)+3, 594 μs. Here, t denotes a guard time between consecutive transmissions. The guard time requires tens of microseconds depending on clock accuracy and the elapsed time after the most recent synchronization event. In this evaluation, the guard time t is set to 150 s, which is a half of the turnaround time. In FIG. 7, when N=24, the elapsed time becomes the maximum value shorter than the coherence time. Consequently, Tₘₚ is 10,494 s in total, which is the duration required for UWB-CR to perform DS-TWR. N=24 is used for the following experiments. However, it is clear that the present invention is not limited to a specific value of N.

### 3. Evaluation for Overshadowing Attacks

The performance of UWB-CR was experimentally evaluated while varying the combination of attack parameters K_{sync} and Kₛₜₛ (i.e., K=(K_{sync}, Kₛₜₛ)). In each attack parameter set, 1,000 ranging sessions were performed using a DS-TWR method. Here, it is assumed that the attacker may achieve the maximum distance reduction for both the response message and the final message. For a channel environment, an outdoor environment is focused in consideration of digital key applications.

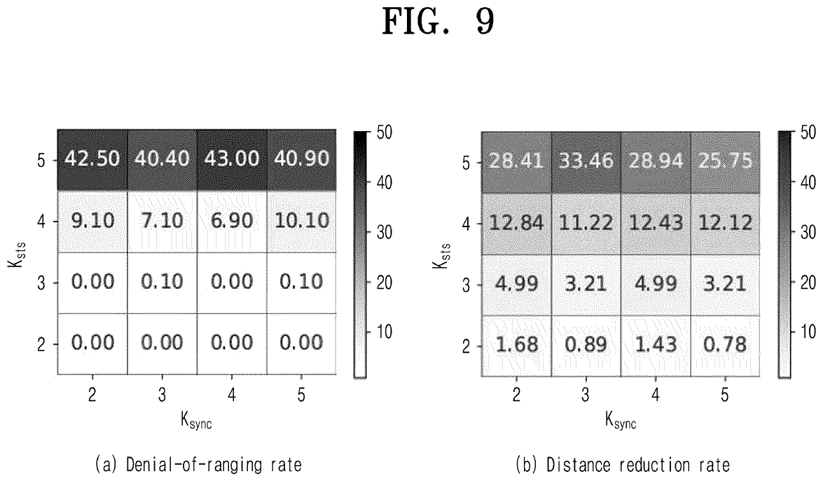

3.1 Attack Success Rate. As described above, the CIR may be manipulated through an overshadowing attack on the SYNC field or the STS field. In the DF case, a frame is not detected due to overshadowing on the SYNC field. When applying code randomization, the probability of frame detection failure in SS-TWR is computed as (7/8)²⁴≈0.04. In DS-TWR, if either the response frame or the final frame is not detected, it is considered as the frame detection failure. The probability of frame detection failure in DS-TWR is (1−(1−(7/8)²⁴)²)≈0.08. In the MToA case, the distance decreases due to overshadowing on the STS field. FIG. 9 shows a denial-of-ranging rate and a distance reduction rate due to manipulated ToA measurement. The denial-of-ranging case is excluded from the distance reduction rate. The denial-of-ranging case begins to occur from Kₛₜₛ=4 and increases significantly at Kₛₜₛ=5, exceeding 40%. Also, the distance reduction rate depends on Kₛₜₛ, but is not affected by K_{sync}. This is a natural result since the ToA is computed on the STS field. The distance reduction rate also significantly increases from Kₛₜₛ=4.

3.2 Distance Error. FIG. 8 is a graph showing the average peak error of the maximum peak Pₛₜₛ and the sync peak P_{sync} as a function of K. As the attack parameter Kₛₜₛ increases, P_{sync} remains stable. On the other hand, Pₛₜₛ exhibits significant fluctuation starting from Kₛₜₛ=4. The results indicate that, when Kₛₜₛ is large, the change in Pₛₜₛ increases the distance reduction rate since the LED algorithm detects the leading edge based on Pₛₜₛ. The results experimentally show that, while Pₛₜₛ may be reliable in most cases, P_{sync} may be more reliable when the attacker overshadows the STS field with high power. When Kₛₜₛ<4, it is more suitable for UWB-CR to compute the ToA using Pₛₜₛ. Conversely, when Kₛₜₛ≥4, it is more effective to compute the ToA using P_{sync}.

It is noteworthy that applying UWB-CR significantly reduces a distance error regardless of the attack power K. In particular, when Kₛₜₛ=2 and 3, there is almost no distance error, but the distance error gradually increases from Kₛₜₛ=4. Since UWB-CR computes the ToA of the response message and the ToA of the final message using Pₛₜₛ or P_{sync}, the distance error depends on an error occurring in two peaks due to the overshadowing attack. Therefore, this suggests that the reference point between two peaks may have been erroneously selected when Kₛₜₛ=5. There are two main reasons why the reference points do not exactly match. That is, (i) if γ=Pₛₜₛ−P_{sync} is close to the BTW, a slightly different peak may be selected as reference, and (ii) P_{sync} may sharply increase in some sessions.

Also, how much UWB-CR reduces the distance error when distance reduction and denial-of-ranging occur is evaluated. As shown in Table 1, applying UWB-CR may reduce the distance error by more than 93% compared to the existing methods when the distance reduce occurs, and may reduce the distance error by more than 99% when denial-of-ranging occurs. Since the BTW does not exceed 100 meters, the occurrence of denial-of-ranging implies the presence of a large maximum peak error. Therefore, P_{sync} is typically used as the reference point in the denial-of-ranging case. The Pₛₜₛ error increases faster than the P_{sync} error under overshadowing attacks. Therefore, although the distance error exceeds 100 meters, applying UWB-CR does not significantly increase the error compared to the distance reduction case.

TABLE 1

Error Reduction Rate

| Kₛₜₛ | Distance Reduction | Denial-of-ranging |
|---|---|---|
| 2 | 97.34 | — |
| 3 | 98.21 | 99.05 |
| 4 | 94.93 | 99.29 |
| 5 | 93.69 | 99.31 |

In Table 1 above, “-” indicates no occurrence of denial-of-ranging.

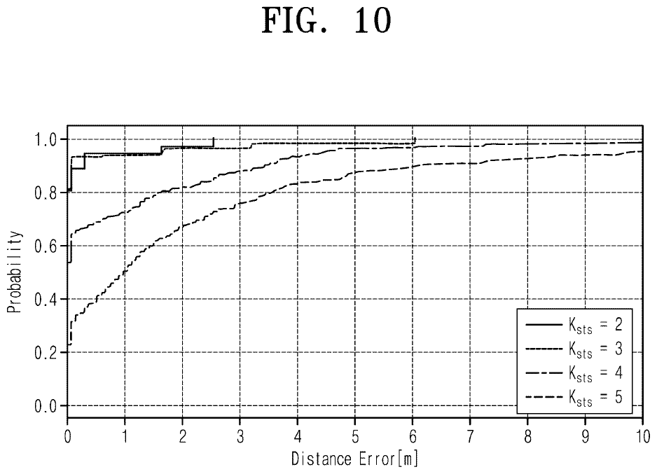

FIG. 10 is a graph showing an empirical cumulative distribution function (ECDF) of a distance error as a function of Kₛₜₛ. When Kₛₜₛ=2, the distance error is less than 3 meters in all ranging sessions. When Kₛₜₛ=3, the distance error is less than 6 meters. However, when Kₛₜₛ=4 and 5, there are sessions in which the distance error exceeds 10 meters. Based on these results, the tolerance error range for determining the correct ToA measurement or the incorrect ToA measurement is set to 3 meters. That is, if the error in DS-TWR is less than threshold δ=40 ns, the ToA measurement is considered to be correct (or accurate). In a real-world environment, the tolerance error range differs for each manufacturer, which significantly affects the system security and accordingly, is generally regarded as exclusive information. In general, considering the tradeoff between the performance and the security, the tolerance error range is within 2 meters. Compared to recent application cases, the 3-meter threshold may be slightly wide, but may effectively mitigate an actual overshadowing attack. Therefore, it is not an issue to adopt this value to apply UWB-CR. Also, the scope of the present invention is not limited to the tolerance error range.

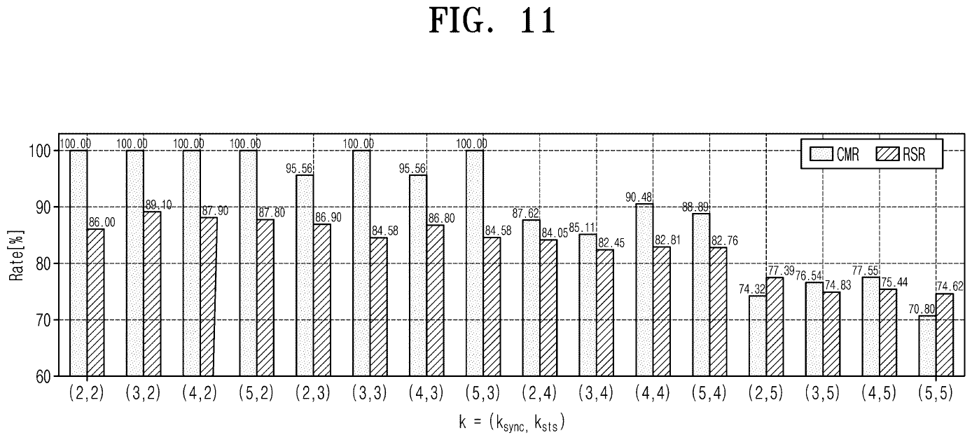

3.3 Performance. The evaluation results show that when K_{sync}=2, 3, 4, and 5, the average DSRs were 91.20%, 91.38%, 91.48%, and 91.68%, respectively. As described above, the results are similar to the probability computed as approximately 92%. FIG. 11 is a graph showing CMR and RSR in outdoor channel environments as a function of K. The CMR and the RSR decrease about 10% from Kₛₜₛ=5 and Kₛₜₛ=4, respectively. It is noteworthy that the distance error may be reduced to 93.69% although the probability of correctly measuring the ToA at Kₛₜₛ=5 is only 75% (see Table 1). The RSR indicates a ratio of successful attempts during the entire session, which also represents the ratio of frames of which detection was successful and ToA was correctly measured. UWB-CR achieves the RSR of 70% or more for all attack parameters K. Note that, when UWB-CR is not applied, the receiver may not detect any frame during a distance detection session under an overshadowing attack, so the RSR is computed as 0%.

### 4. Channel Conditions

To implement a realist simulation, a wireless channel model provided from the IEEE 802.15.4a task group is used. Compared to an additive white Gaussian noise (AWGN) channel, the impact of attack pulses on the CIR varies depending on non-ideal channel conditions. The IEEE 802.15.4a task group provides the wireless channel model for four environments, residential, office, outdoor, and industrial environments. Since line-of-sight (LoS) and non-line-of-sight (NLoS) conditions are present in each environment, four different channel conditions (i.e., LoS/LoS, LoS/NLoS, NLoS/LoS, and NLoS/NLoS) are present between a victim and an attacker device. For example, in this evaluation, the LoS/NLoS channel condition indicates that the initiator and the responder are present in the LoS channel, and the attacker and the victim (initiator or responder) are present in the NLoS channel. Therefore, in the present invention, UWB-CR is evaluated under 16 different channel conditions.

The performance and the distance error are evaluated according to channel conditions, ranging method, and K. Since K_{sync} barely affects the CMR and the RSR (see FIG. 8), the attack parameter K is set to K=(2,2), (3,3), (4,4), and (5,5) (Table 2). In each Kₛₜₛ, residential and office environments exhibit higher CMR and RSR compared to outdoor and industrial environments. Also, LoS/LoS and LoS/NLoS channel conditions exhibit higher CMR and RSR compared to NLoS/LoS and NLoS/NLoS conditions. When two devices are present in the NLoS channel, a plurality of peaks appear due to multi-path components, resulting in increasing the ToA error. Therefore, the attacker may make a most effect attack under the NLoS/LoS channel condition. Conversely, it is most difficult for the attacker to make a successful attack under LoS/NLoS channel condition. Experimental results show that the CMR and the RSR are higher in NLoS/NLoS than in LoS/LoS, which indicates that the attacker may more effectively perform an attack in the NLoS/NLoS environment. In particular, these results outstandingly appear in the industrial environment in which the CMR and the RSR were significantly reduced when the initiator had the NLoS channel for the responder. Even in the industrial environment, applying UWB-CR reduced the distance error compared to a case in which UWB-CR was not applied, but the distance error still exceeded the 3-meter tolerance range. Therefore, for applications used in the industrial environment, it is appropriate to set the tolerance range to 6 meters when applying UWB-CR to increase the CMR and the RSR.

TABLE 2

| | | | Channel Environment | | | | | | | |
|---|---|---|---|---|---|---|---|---|---|---|
| | | | Residential | | | | Office | | | |
| | | | L/L | L/N | N/L | N/N | L/L | L/N | N/L | N/N |
| K = | SS | CMR | 100.00 | 100.00 | 87.50 | 100.00 | 100.00 | 100.00 | 100.00 | 100.00 |
| (2, 2) | | RSR | 95.50 | 93.90 | 95.20 | 93.20 | 94.39 | 95.10 | 94.19 | 93.30 |
| | DS | CMR | 100.00 | 100.00 | 100.00 | 100.00 | 100.00 | 100.00 | 100.00 | 100.00 |
| | | RSR | 90.89 | 89.29 | 89.55 | 90.60 | 88.78 | 90.08 | 90.88 | 91.27 |
| K = | SS | CMR | 100.00 | 100.00 | 100.00 | 100.00 | 100.00 | 97.14 | 100.00 | 100.00 |
| (3, 3) | | RSR | 93.39 | 94.10 | 92.69 | 91.78 | 94.28 | 94.08 | 92.68 | 93.29 |
| | DS | CMR | 100.00 | 100.00 | 97.56 | 100.00 | 100.00 | 100.00 | 100.00 | 93.94 |
| | | RSR | 88.18 | 90.24 | 89.97 | 88.41 | 90.78 | 89.18 | 89.69 | 89.96 |
| K = | SS | CMR | 97.14 | 96.05 | 91.11 | 84.62 | 96.55 | 100.00 | 88.00 | 82.86 |
| (4, 4) | | RSR | 93.63 | 92.93 | 89.91 | 90.39 | 94.22 | 96.27 | 93.34 | 92.12 |
| | DS | CMR | 98.14 | 92.22 | 85.71 | 84.15 | 93.92 | 97.73 | 82.35 | 85.14 |
| | | RSR | 88.63 | 89.91 | 86.32 | 85.51 | 89.23 | 89.61 | 87.87 | 89.26 |
| K = | SS | CMR | 73.97 | 79.17 | 64.71 | 50.00 | 81.43 | 80.49 | 52.00 | 50.98 |
| (5, 5) | | RSR | 90.67 | 93.06 | 85.27 | 85.27 | 91.77 | 91.65 | 90.21 | 90.28 |
| | DS | CMR | 82.11 | 79.89 | 68.92 | 62.50 | 87.38 | 83.33 | 63.64 | 69.34 |
| | | RSR | 82.03 | 80.67 | 76.97 | 76.72 | 84.98 | 82.20 | 77.90 | 81.22 |
| K = | SS | w/o | 11.26 | 10.02 | 9.14 | 9.61 | 6.68 | 10.20 | 13.08 | 14.00 |
| (2, 2) | | w/ | 0.00 | 0.51 | 0.47 | 0.00 | 0.00 | 0.00 | 0.00 | 0.00 |
| | DS | w/o | 5.84 | 8.14 | 5.70 | 1.89 | 8.33 | 8.19 | 6.27 | 4.28 |
| | | w/ | 0.00 | 0.00 | 0.27 | 0.17 | 0.00 | 0.21 | 0.00 | 0.22 |
| K = | SS | w/o | 14.49 | 13.11 | 12.08 | 13.39 | 16.55 | 14.77 | 9.22 | 12.39 |
| (3, 3) | | w/ | 0.13 | 0.01 | 0.08 | 0.00 | 0.01 | 0.16 | 0.06 | 0.08 |
| | DS | w/o | 7.98 | 8.05 | 7.97 | 9.07 | 8.28 | 7.84 | 6.80 | 8.67 |
| | | w/ | 0.03 | 0.06 | 0.25 | 0.19 | 0.03 | 0.05 | 0.03 | 0.94 |
| K = | SS | w/o | 18.03 | 18.35 | 26.50 | 22.31 | 15.72 | 17.19 | 21.01 | 22.45 |
| (4, 4) | | w/ | 0.18 | 0.50 | 1.34 | 2.29 | 0.33 | 0.09 | 1.84 | 2.99 |
| | DS | w/o | 12.86 | 12.70 | 21.51 | 22.76 | 15.25 | 13.49 | 23.00 | 18.29 |
| | | w/ | 0.29 | 0.67 | 1.33 | 1.27 | 0.58 | 0.52 | 1.48 | 1.49 |
| K = | SS | w/o | 28.59 | 28.36 | 31.20 | 42.83 | 21.99 | 26.67 | 35.43 | 34.66 |
| (5, 5) | | w/ | 2.92 | 2.42 | 4.89 | 6.18 | 2.37 | 2.27 | 5.84 | 6.95 |
| | DS | w/o | 26.98 | 20.93 | 37.68 | 36.92 | 27.67 | 24.54 | 35.32 | 34.69 |
| | | w/ | 1.50 | 1.55 | 3.23 | 3.83 | 1.39 | 1.54 | 3.34 | 2.75 |

| | | | Channel Environment | | | | | | | |
|---|---|---|---|---|---|---|---|---|---|---|
| | | | Outdoor | | | | Industrial | | | |
| | | | L/L | L/N | N/L | N/N | L/L | L/N | N/L | N/N |
| K = | SS | CMR | 100.00 | 100.00 | 92.86 | 100.00 | 100.00 | 100.00 | 70.97 | 79.49 |
| (2, 2) | | RSR | 91.80 | 82.90 | 90.70 | 91.40 | 95.30 | 93.70 | 78.23 | 78.51 |
| | DS | CMR | 100.00 | 92.86 | 81.82 | 90.91 | 100.00 | 100.00 | 76.00 | 88.89 |
| | | RSR | 86.00 | 87.20 | 84.17 | 83.35 | 89.50 | 87.50 | 74.37 | 72.16 |
| K = | SS | CMR | 100.00 | 100.00 | 75.00 | 88.89 | 100.00 | 100.00 | 61.29 | 78.79 |
| (3, 3) | | RSR | 92.00 | 90.49 | 85.77 | 87.53 | 93.60 | 94.30 | 70.25 | 69.98 |
| | DS | CMR | 100.00 | 100.00 | 92.00 | 78.26 | 100.00 | 99.11 | 55.32 | 57.14 |
| | | RSR | 84.58 | 86.50 | 78.61 | 77.13 | 89.70 | 88.99 | 57.96 | 58.52 |
| K = | SS | CMR | 94.55 | 92.68 | 65.38 | 77.78 | 97.64 | 90.65 | 50.88 | 42.86 |
| (4, 4) | | RSR | 89.24 | 89.79 | 81.14 | 81.73 | 93.02 | 92.70 | 60.69 | 60.70 |
| | DS | CMR | 90.48 | 90.43 | 80.00 | 70.97 | 95.95 | 98.23 | 43.24 | 55.43 |
| | | RSR | 82.81 | 83.41 | 75.19 | 73.76 | 87.86 | 90.84 | 47.74 | 51.61 |
| K = | SS | CMR | 67.21 | 67.21 | 49.12 | 54.79 | 79.13 | 87.07 | 33.02 | 34.57 |
| (5, 5) | | RSR | 86.61 | 86.21 | 83.24 | 78.54 | 90.64 | 90.73 | 53.75 | 59.86 |
| | DS | CMR | 70.80 | 70.91 | 61.94 | 59.06 | 81.71 | 86.42 | 36.89 | 35.71 |
| | | RSR | 74.62 | 75.00 | 64.94 | 66.03 | 80.12 | 83.41 | 39.87 | 36.07 |
| K = | SS | w/o | 12.81 | 7.75 | 6.77 | 7.89 | 14.73 | 16.61 | 5.78 | 6.06 |
| (2, 2) | | w/ | 0.00 | 0.00 | 0.26 | 0.00 | 0.00 | 0.02 | 3.10 | 1.55 |
| | DS | w/o | 5.38 | 7.50 | 4.89 | 2.72 | 7.47 | 8.10 | 5.99 | 5.21 |
| | | w/ | 0.02 | 0.62 | 1.18 | 0.43 | 0.00 | 0.00 | 1.74 | 1.35 |
| K = | SS | w/o | 15.42 | 15.00 | 29.72 | 24.39 | 16.51 | 14.38 | 16.40 | 8.18 |
| (3, 3) | | w/ | 0.01 | 0.04 | 2.47 | 2.19 | 0.00 | 0.00 | 4.35 | 2.72 |
| | DS | w/o | 7.12 | 7.46 | 25.39 | 15.80 | 8.07 | 8.06 | 25.00 | 19.33 |
| | | w/ | 0.01 | 0.19 | 1.05 | 2.71 | 0.03 | 0.18 | 3.22 | 3.66 |
| K = | SS | w/o | 18.95 | 20.09 | 38.09 | 29.16 | 16.87 | 19.26 | 47.05 | 36.82 |
| (4, 4) | | w/ | 0.71 | 0.96 | 3.92 | 3.60 | 0.35 | 1.28 | 5.45 | 5.29 |
| | DS | w/o | 20.54 | 15.00 | 39.38 | 44.65 | 12.44 | 10.01 | 48.87 | 45.17 |
| | | w/ | 0.79 | 0.70 | 2.38 | 2.47 | 0.45 | 0.22 | 5.29 | 4.17 |
| K = | SS | w/o | 31.70 | 30.96 | 45.89 | 47.10 | 22.56 | 20.61 | 46.20 | 47.31 |
| (5, 5) | | w/ | 4.37 | 4.22 | 5.08 | 6.64 | 3.24 | 1.85 | 7.83 | 6.17 |
| | DS | w/o | 35.21 | 35.06 | 45.28 | 47.88 | 22.01 | 20.42 | 52.92 | 53.24 |
| | | w/ | 2.54 | 2.66 | 3.45 | 3.62 | 1.90 | 1.35 | 5.66 | 5.76 |

Table 3 shows the distance error when denial-of-ranging occurs in different channel environments. In SS-TWR, when K=(4,4), denial-of-ranging occurred only in the industrial environment. In each environment, the average distance error value is based on four conditions (i.e., L/L, L/N, N/L, and N/N). If an overshadowing attack occurs, the distance error exceeds 100 meters when UWB-CR is not applied. However, if UWB-CR is applied, the distance error may be reduced to be within 6.97 meters in SS-TWR and 4.57 meters in DS-TWR.

TABLE 3

| | | Channel Environment | | | |
|---|---|---|---|---|---|
| K | TWR | Residential | Office | Outdoor | Industrial |
| (4, 4) | SS | — | — | — | 4.86 |
| | DS | 2.76 | 2.16 | 2.56 | 3.31 |
| (5, 5) | SS | 6.97 | 5.11 | 4.04 | 5.27 |
| | DS | 3.58 | 3.06 | 3.19 | 4.57 |

The present invention proposes UWB-CR that enables accurate ranging even in a situation in which an overshadowing attack is present. Also, considering the ghost peak attack and the UWBAD attack proven to be a practical threat to a UWB ranging system, a threat model that defines a generalized attack targeting a specific field is established. UWB-CR is designed to transmit a plurality of frames using different code sequences in a single ranging session. In the case of using the plurality of frames, there is a probability that at least one frame may match a code sequence injected into the SYNC field by the attacker. Also, UWB-CR extracts reciprocal features to enable the accurate ToA computation without relying on the LED algorithm since the LED algorithm is known to be vulnerable to overshadowing attacks. Through a series of experiments, it is demonstrated that UWB-CR may effectively reduce the distance error caused by overshadowing attacks.

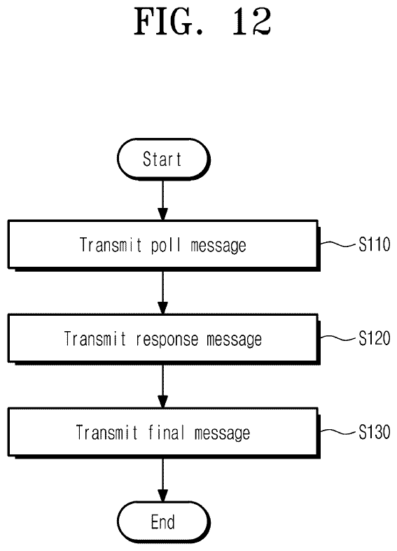

FIG. 12 is a flowchart illustrating an ultra-wideband (UWB) ranging method according to an example embodiment of the present invention.

Referring to FIG. 12, the UWB ranging method may be performed by a computing device including at least a processor or controller and/or memory. That is, at least some of operations that constitute the ranging method may be understood as the operation of the processor or the controller included in the computing device. More specifically, for example, the computing device may be implemented as some components (electronic control unit (ECU) or UWB ranging device) of a vehicle, a smartphone, a smart key, and the like, and may be named as an initiator and a responder depending on a transmission entity of a message. That is, the UWB ranging method may be understood as a communication method between the initiator (smart key or vehicle) and the responder (vehicle or smart key). When describing the UWB ranging method below, detailed description related to the overlapping content of the aforementioned description will be omitted.

A poll message is transmitted by the initiator (S110). The poll message may include information on a transmission (or send) time of the poll message.

In response to reception from the initiator, the responder transmits response messages (S120). Here, the responder may sequentially transmit the predetermined number (e.g., N (N is natural number of 2 or more)) of response messages at predetermined intervals. Here, the responder may randomly select and transmit a preamble of the SYNC field within each response message. Detailed description related to a preamble selection technique is omitted.

Although an overshadowing attack is present, at least one of response messages containing different preamble codes may be detected by the initiator. Information on the detected response message (e.g., index of response message) may be included in a message subsequently transmitted from the initiator (e.g., payload of final message subsequently transmitted from initiator) and transmitted to the responder. Here, since not all of the N final messages are detected by the responder, information on the detected response message may be included in all of the N final messages and transmitted.

Also, the responder may measure reciprocal features for estimating the ToA from the poll message. Measurement of reciprocal features may be performed immediately after receiving the poll message, while transmitting the response message, or after transmitting the response message. Description related to the measured reciprocal features is omitted. According to an example embodiment, the measured reciprocal features may be included in the response message along with the reception time of the poll message, the transmission time of the response message, and at least one CIR, and thereby transmitted.

In response to reception of the response message, the initiator transmits final messages (S130). That is, the initiator may sequentially transmit N final message at predetermined intervals at a predetermined point in time at which a predetermined amount of time elapses after transmission of a predetermined response message is completed. Here, the initiator may randomly select and transmit a preamble of the SYNC field within each final message. According to an example embodiment, the final message may further include information on the detected response message (information on peak and the like as a result of cross-correlation). Similar to a case of the response message, information on the final message detected by the responder (information, index of final message) may be included in a message subsequently transmitted from the responder and may be transmitted to the initiator.

The responder that detects at least one of the N final messages may estimate the ToA of the response message and/or the final message.

Through the aforementioned process, a single round (or session) including transmission and reception of the poll message, the response message, and the final message is completed. Through this, the responder may measure the distance based on the estimated ToA, and may update the distance from the initiator. Also, it is assumed that information required in the process in which the initiator and/or responder compute or estimate the ToA and/or ToF is included in a message transmitted therebetween and shared, or shared in advance. The aforementioned equations and the like may be utilized in this process.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

1. A ranging method between an initiator and a responder that perform ultra-wideband (UWB) ranging, the method comprising:
a first transmission operation in which the initiator transmits a poll message;
a second transmission operation in which the responder receives the poll message and sequentially transmits N response messages at predetermined time intervals, where N denotes a natural number of 2 or more; and
a third transmission operation in which the initiator sequentially transmits N final messages at predetermined time intervals after the N response messages are transmitted,
wherein a preamble code within the synchronization (SYNC) field of each of the N response messages is selected in a predefined manner.

2. The method of claim 1, wherein the second transmission operation computes a first channel impulse response (CIR) of the SYNC field of the poll message and a second channel impulse response of the scrambled timestamp sequence (STS) field of the poll message.

3. The method of claim 2, wherein the second transmission operation computes a time interval (α) between the maximum peak (P_{sts,poll}) and the leading edge (P_{toa,poll}) of the STS field of the poll message, a time interval (β) between the maximum peak (P_{sync,poll}) and the leading edge (P_{toa,poll}) of the SYNC field of the poll message, and a time interval (γₚ) between the maximum peak (P_{sync,poll}) of the SYNC field and the maximum peak (P_{sts,poll}) of the STS field of the poll message.

4. The method of claim 3, further comprising:
an operation in which the responder computes a time of arrival (ToA) of the final message after the N final messages are transmitted,
wherein the ToA is computed as a value acquired by adding 3 to a maximum peak point generated as a cross-correlation result of the SYNC field of the detected final message.

5. The method of claim 3, further comprising:
an operation in which the responder computes a time of arrival (ToA) of the final message after the N final messages are transmitted,
wherein the ToA is computed as a value acquired by subtracting a from a maximum peak point generated as a cross-correlation result of the STS field of the detected final message.
